(19) United States
(12) Patent Application Publication
(10) Pub. No.: US 2008/0117792 A1
(43) Pub. Date: May 22, 2008

(54) Three-dimensional storage medium

(76) Inventors: Marshall R. Rowe, Chicago, IL (US); James G. Bennett, Glen Ellyn, IL (US); John C. Szpicki, Homer Glen, IL (US)

Correspondence Address: McCracken & Frank LLP, 311 S. Wacker Drive, Suite 2500, Chicago, IL, 60606, US

(21) Appl. No.: 11/602,016

(22) Filed: Nov. 20, 2006

(51) Int. Cl. G11B 7/24

(52) U.S. Cl. 369/275.3

(57) ABSTRACT

A medium for storing data includes a rotationally symmetric body, wherein the body is divided into a plurality of independently positionable segments, and a recordable substrate is affixed to a surface of at least one of the segments. The medium further includes at least one mount to enable the segments to be coupled to a drive mechanism.

### CROSS REFERENCE TO RELATED APPLICATIONS

Not applicable

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention relates generally to a computer storage medium for storing data, and more particularly to a three-dimensional computer storage medium.

2. Description of the Background of the Invention

Compact disks (CDs) and digital video (versatile) disks (DVDs) are optical storage mediums that allow users to encode data onto the disk and to access data from the disk using known methods. CDs and DVDs generally have the same dimensions and are typically flat circular disks with a diameter of 120 mm and an opening in the center of the disk defining a hole with a diameter of 15 mm. The disk is clamped into a player or disk drive utilizing the center hole. Occasionally, non-circular shaped disks are used as promotional items, for example, a disk the general size and shape of a rectangular business card. However, such non-rotationally symmetric disks are relatively uncommon, in part, because they have an offset center of mass, which may cause damaging vibrations when rotated in a disk drive.

Data is stored on the disk in the form of a compact spiral track of microscopic indentations or pits covered by a thin layer of reflective material. CD and DVD drives access the data stored on the disk utilizing a moveable read head located on a rail spanning the radius of the disk. The read head includes a laser and a photodiode sensor, wherein the laser is focused on the spiral track and the reflection of the laser caused by the pits is measured by the sensor. The variation in the measured laser intensity is decoded to interpret the data stored on the disk. The disk is rotated on a spindle and the read head moves between the center and outer radius of the disk to randomly access the data stored thereon. Data can be written to the disk using a similar process, wherein a laser is applied to the spiral track to encode data thereon.

Flat, circular CDs and DVDs are limited in their storage capacity and the speed in which the data is accessed due to their geometry and physical characteristics. In order to increase storage capacity and data access speed, it would be desirable to develop a storage medium with a greater surface area that can be quickly read from and written to.

### SUMMARY OF THE INVENTION

According to one embodiment, a medium for storing data includes a rotationally symmetric body, wherein the body is divided into a plurality of independently positionable segments, and a recordable substrate is affixed to a surface of at least one of the segments. The medium further includes at least one mount to enable the segments to be coupled to a drive mechanism.

According to another embodiment, an apparatus for accessing data stored on a substrate affixed to a surface of an ellipsoidal body coupled to the apparatus includes a guide external to the ellipsoidal body, a read head moveably disposed on the guide, a motor for spinning the ellipsoidal body, and a controller coupled to the apparatus for positioning the read head along the guide.

According to yet another embodiment, a method for accessing data stored on a substrate affixed to a surface of a body includes the step of providing a rotationally symmetric body that is divided into a plurality of segments, wherein a recordable substrate is affixed to a surface of at least one of the segments. The method further includes the steps of controlling each segment to spin independently of the other segments and moving a plurality of read heads along at least one guide located externally to the body.

Other aspects and advantages of the present invention will become apparent upon consideration of the following detailed description.

### BRIEF DESCRIPTION OF THE DRAWINGS

FIG. 1 is an isometric view of an ellipsoidal storage medium according to an embodiment of the present invention;

FIG. 2 is an isometric view of a segmented ellipsoidal storage medium according to another embodiment of the present invention;

FIG. 3 is an isometric view of a spherical storage medium according to yet another embodiment of the present invention;

FIG. 4 is an isometric view of a segmented spherical storage medium according to a further embodiment of the present invention;

FIG. 5A is an isometric view of a segmented cylindrical storage medium according to yet a further embodiment of the present invention;

FIG. 5B is a cross-sectional view of an embodiment of a segmented cylindrical storage medium similar to the embodiment of FIG. 5A;

FIG. 5C is a cross-sectional view of another embodiment of a segmented cylindrical storage medium similar to the embodiment of FIG. 5A;

FIG. 6 is a side cross-sectional view of a storage medium similar to the embodiment of FIG. 1 housed in a drive;

FIG. 7 is a side cross-sectional view of a storage medium similar to the embodiment of FIG. 2 housed in a drive;

FIG. 8 is a top cross-sectional view of a storage medium similar to the embodiment of FIG. 3 housed in a drive;

FIG. 9 is a side cross-sectional view of a storage medium similar to the embodiment of FIG. 4 housed in a drive;

FIG. 10 is a top cross-sectional view of a storage medium similar to the embodiment of FIG. 5A housed in a drive;

FIG. 11 is a diagrammatic isometric view of a drive according to an embodiment of the present invention;

FIG. 12 is a diagrammatic isometric view of a drive according to another embodiment of the present invention;

FIG. 13 is a diagrammatic isometric view of a drive according to yet another embodiment of the present invention;

FIG. 14 is a top cross-sectional view of an embodiment of a segmented spherical storage medium with a recordable substrate affixed to the area between the segments housed in a drive; and

FIG. 15 is a top cross-sectional view of another embodiment of a segmented spherical storage medium with a recordable substrate affixed to the area between the segments housed in a drive.

### DETAILED DESCRIPTION OF THE PREFERRED EMBODIMENTS

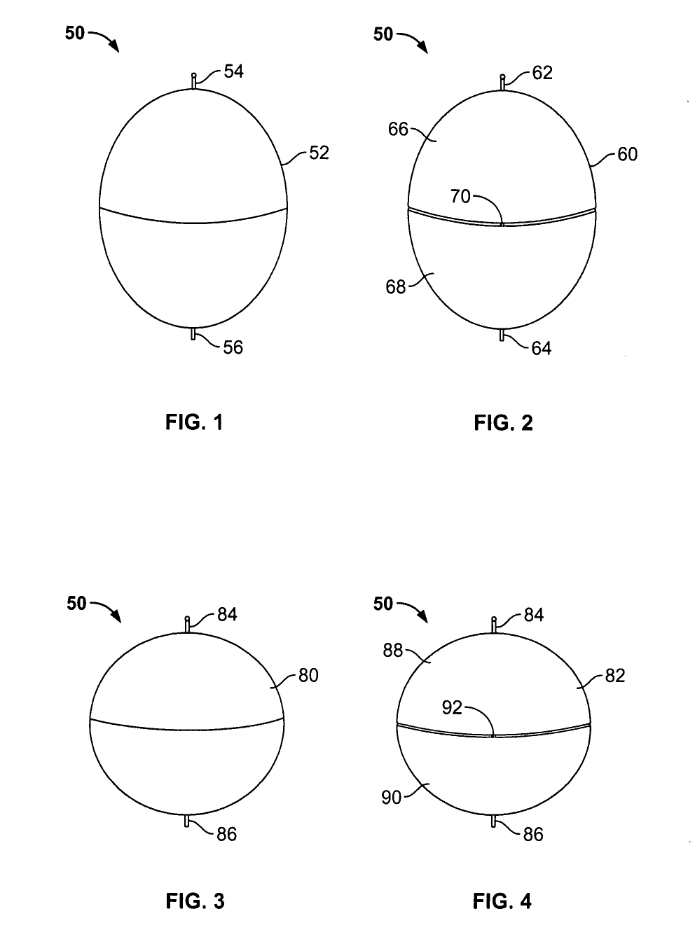

FIGS. 1-5 show embodiments of a storage medium of the present invention including three-dimensional bodies. Preferably, the storage medium may be of any three-dimensional, rotationally symmetric body, for example, a cylinder, an ellipsoid, a sphere, an ovoid shape, and the like. The storage medium may be made of any appropriate material such that data can be accessed and recorded. In one embodiment, the storage medium is made of a light-weight, durable material. For example, the storage medium may include a base of polycarbonate plastic and a thin coating of aluminum, silver, silver alloy, or gold similar to that of typical CDs and DVDs. In the case of recordable and rewritable CDs and DVDs, the storage medium may optionally include a thin layer of reflective dye, wherein varying laser intensity records data onto the medium by altering the reflective properties of the dye. In other embodiments, the storage medium may be made of any suitable material for optical, magnetic, magneto-optical, or any other known method of information storage and may encode information in any appropriate format, for example, digital and analog formats, or longitudinal, perpendicular and multilayer magnetic recording formats. Additionally, data may be interleaved on the storage medium to increase efficiency. Interleaving arranges data in sectors on the medium in a noncontiguous arrangement so that the disk drive can access and store data from one sector into a buffer and immediately access and store data from the next sector as the storage medium is spinning. The noncontiguous arrangement enables the disk drive to constantly read data from the storage medium without having to wait for the next data sector to align. Providing a storage medium with multiple independently rotatable segments allows data to be interleaved on each segment individually and/or across the segments to further increase efficiency.

In one embodiment, the storage medium includes at least one mount to facilitate securing the storage medium to an apparatus or drive mechanism. The drive mechanism typically includes a motor for spinning the medium and a read and/or write head for accessing and/or storing data on the storage medium. In another embodiment, the storage medium includes two spindles on opposite ends of the body about which the storage medium is rotated. However, other embodiments of the storage medium may include a greater or lesser number of mounts that are indentations, protrusions, spindles, openings, or any other suitable type of structure for securing the medium to the drive. For example, the storage medium may be clamped to a drive using a central opening similar to that of CDs and DVDs.

In the embodiment of FIG. 1, a storage medium 50 is an ellipsoidal body 52 that includes a first and second mount 54, 56 positioned opposite each other on a rotational axis of the medium. The first and second mounts 54, 56 are spindles extending from opposite poles of the storage medium 50. However, in other embodiments the mounts can be of any suitable structure for securing the medium to an appropriate drive. In particular, the mounts 54, 56 are positioned on the major axis of the ellipsoidal body 52. However, in other embodiments, the mounts may be positioned on the minor axis. Generally, the mounts 54, 56 are placed on a rotationally symmetric axis of the ellipsoidal body 52 to minimize instability when the body is rotating.

FIG. 2 shows another embodiment of the storage medium 50 that is a segmented ellipsoidal body 60. The storage medium 50 includes a first and second mount 62, 64 similar to the mounts in FIG. 1 that are positioned on opposite poles along the major axis of the ellipsoidal body 60. The ellipsoidal body 60 is segmented into a first and second hemisphere 66, 68 along the minor axis of the ellipsoidal body 60. In other embodiments, the mounts may be placed along the minor axis and the ellipsoid may be segmented along its major axis. As noted above, the mounts 62, 64 are located on a rotationally symmetric axis of the ellipsoidal body 60 and the body is segmented along a line perpendicular to the rotational axis.

In FIG. 2, the first and second hemispheres 66, 68 are equal halves of the ellipsoidal body 60. However, in other embodiments, the first and second hemispheres need not be equal halves and may have different proportions. The first and second hemispheres 66, 68 engage a central shaft 70 extending between the first and second mounts 62, 64, and there is a small gap between the hemispheres to allow each hemisphere to spin independently of the other. Suitable connections inside the ellipsoidal body 60 form a frame structure (not shown) within the body and also allow each hemisphere 66, 68 to be rotated independently of the other. Such connections and frame structures would be well known to one of ordinary skill in the art, for example, a series of arms and ribs may form a structure to maintain the shape of the body and an arrangement of bearings and gears may be included to allow the segments to spin independently of each other. In other embodiments, the storage medium may be further segmented, wherein each segment can be rotated independently of the other, i.e., the speed and/or direction of rotation of each segment can be independently controlled. Controlling these parameters helps make interleaving effective by timing the rotation of the storage medium to synchronize the position of the read/write head and the next data sector to be accessed.

The storage medium of FIGS. 3 and 4 are spherical and segmented spherical bodies 80, 82, respectively. First and second mounts 84, 86 are positioned on opposite poles, wherein the first and second mounts are spindles similar to the mounts in FIGS. 1 and 2. In FIG. 4, the spherical body is divided into first and second hemispheres 88, 90 along the equator between the first and second mounts 84, 86. The first and second hemispheres 88, 90 engage a central structure 92 extending between the poles such that the hemispheres can rotate independently of each other. Further segmenting of the spherical body may be appropriate in other embodiments, wherein each segment is independently rotatable of the others.

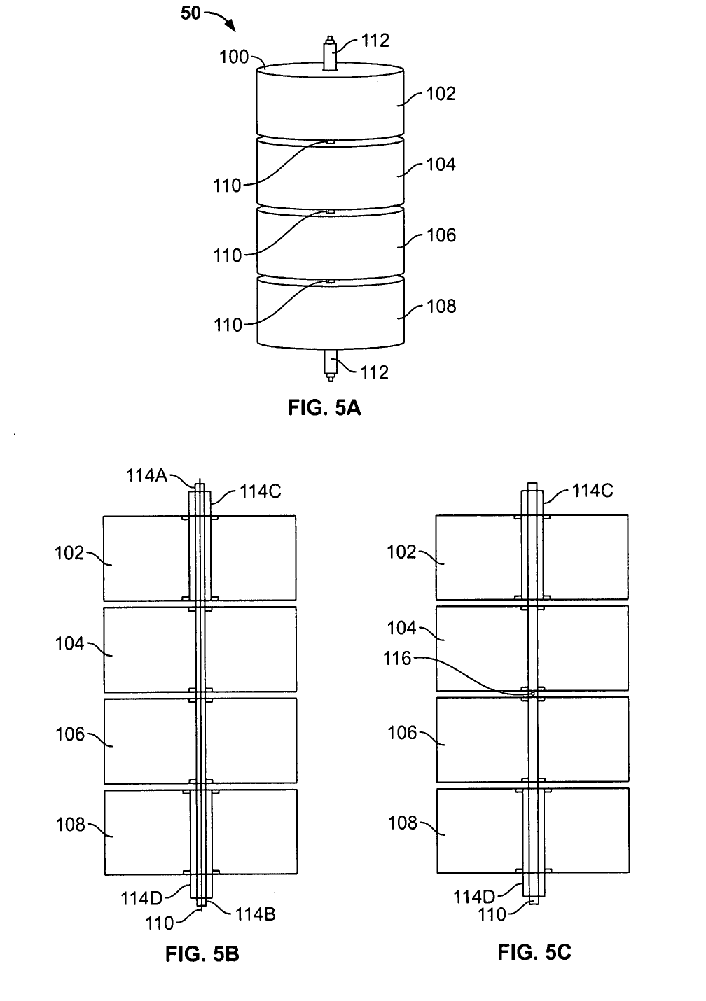

FIG. 5A shows a storage medium 50 that has a segmented cylindrical body 100. The body is divided into four segments 102, 104, 106, 108 along lines perpendicular to the height of the body so that the storage medium is divided into four generally equal cylindrical bodies. A spindle 110 extends through the radial center of the storage medium and extends beyond the ends to form mounts 112. The four segments 102-108 are independently rotatable and may be supported by an internal frame structure connected to the spindle. In other embodiments, the cylinder may include a greater or lesser number of independently rotatable segments that can be of varying sizes.

FIGS. 5B and 5C show embodiments of the internal frame structure that facilitate the independent rotation of the four segments 102-108 of FIG. 5A. Spindle 110 is a solid core drive shaft surrounded by a plurality of hollow drive shafts 114A-D engaged to the segments 102-108. In one embodiment, inner drive shafts 114A, 114B engage the middle two segments 104, 106 and are generally positioned over respective halves of the spindle 110. Outer drive shafts 114C, 114D generally correspond with and are engaged to the outer segments 102, 108, respectively, and are positioned over the first and second drive shafts 114A, 114B. In another embodiment shown in FIG. 5C, the spindle 110 itself engages the middle two segments 104, 106 and is segmented between the middle segments via a rotational joint 116 that allows each segment of the spindle to rotate independently of the other. Outer hollow drive shafts 114C, 114D generally correspond with and are engaged to the outer segments 102, 108, respectively, and are positioned over the spindle 110. As a result, a motor (not shown) can operatively engage the spindles and hollow drive shafts to rotate each segment independently. These embodiments can be expanded to facilitate the independent rotation of any number of segments and can be used with storage mediums of any shape, for example, ellipsoidal or spherical storage mediums.

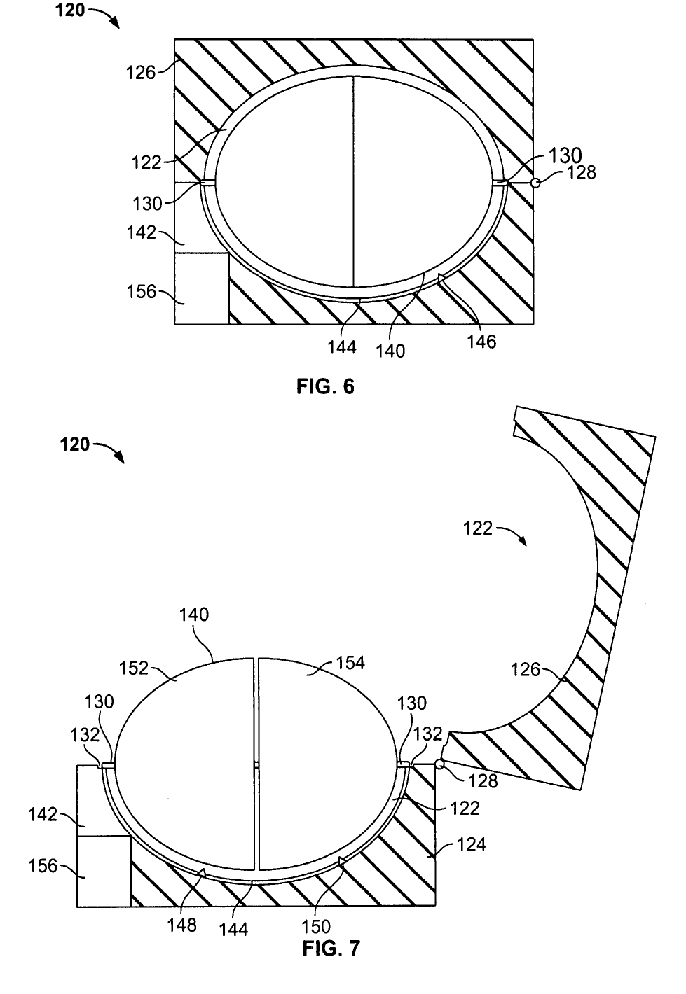

Turning now to FIGS. 6-10, various drive mechanisms for accessing data from the storage medium are shown. Read heads are used to access the information stored on the surface of the storage medium using known technologies, such as that used in CDs, laserdiscs, DVDs, minidisks, Blu-ray disks, holographic versatile disks, magnetic tape, flash memory, and the like. In one embodiment, an optical read head includes a laser and a photodiode sensor for interpreting the data encoded on the surface of the storage medium. Additionally, the drive may include a write head for recording data onto the medium by any known technology, such as those listed above. Generally, the drive includes a guide or rail for maintaining the read/write head at a predetermined distance, equidistant from the surface of the storage medium. The read/write head is moveable along the guide to randomly access or record data on the storage medium. In another embodiment, the guide or rail itself is also moveable with respect to the drive. Typically, a motor is coupled to the drive, either internally or externally, to spin the storage medium and/or guide and to move the read/write head. Additionally, the drive may include a controller, such as, hardware and/or software for controlling the components of the drive, interpreting the data stored on the storage medium, and converting the data into audio or visual outputs, for example. If desired, the drive may further include a power supply either coupled within the drive or coupled externally to the drive for supplying electric power to the components. The drive can be adapted to interface with other components, for example, a personal computer, a display device, a keyboard, a mouse or other input device, wired or wireless internet, and the like.

In FIGS. 6-10 the storage medium is coupled to a drive 120 for accessing the data stored on the medium and/or for storing data onto the medium. The drive 120 has an opening 122 adapted to generally conform to the outer surface of the storage medium. The drive may be made of two or more separable portions such that the drive can be opened and closed and the storage medium can be placed therein and removed. For example, the drive may include a base portion 124 and a lid portion 126 that separate about a hinge 128 (as seen more clearly in FIGS. 7 and 9). This arrangement protects the inside of the drive and the storage medium during read/write operations or when the device is not in operation, and allows easy access for removal of the storage medium and maintenance of the drive. The storage medium may be secured in the drive 120 via spindles 130 that are either located in the drive and engaged to opposite ends of the storage medium or located on opposite poles of the storage medium and engaged by seat portions 132 in the drive. The storage medium may be rotated about any axis, for example, a horizontally aligned axis, a vertically aligned axis, or some other angled axis.

In FIGS. 6 and 7, an ellipsoidal storage medium 140, similar to the embodiments of FIGS. 1 and 2 is housed in a drive 120. In FIGS. 6 and 7 the storage medium 140 is rotated about a horizontally aligned axis; however, the axis may be aligned at any orientation. In FIG. 6, the drive 120 includes spindles 130 that engage the storage medium 140 at opposite poles thereof. Alternatively, in FIG. 7, the storage medium 140 includes the spindles 130 on opposite poles thereof that are clamped in seat portions 132 of the drive 120. A motor 142 is coupled to the storage medium 140 via the spindles 130 or seat portions 132 to rotate the medium. A guide rail 144 extends between the spindles 130 or seat portions 132 along an arc that is generally equidistant at all points thereof from the surface of the storage medium 140.

In FIG. 6, a single read head 146 is moveably positioned on the rail 144. In FIG. 7, a first and second read head 148, 150 are positioned on the rail 144 for accessing data on respective segments of the storage medium 152, 154. The read heads may include or be replaced with write heads to encode data onto any location of the storage medium. A controller 156 is included for positioning the read/write heads and for controlling the operation of the drive 120. Positioning the read heads in a controlled fashion along the rail as the ellipsoidal body is spinning enables the read heads to randomly access data encoded on the storage medium. Similarly, controlling the position of the write heads allows the write heads to randomly encode data on the storage medium.

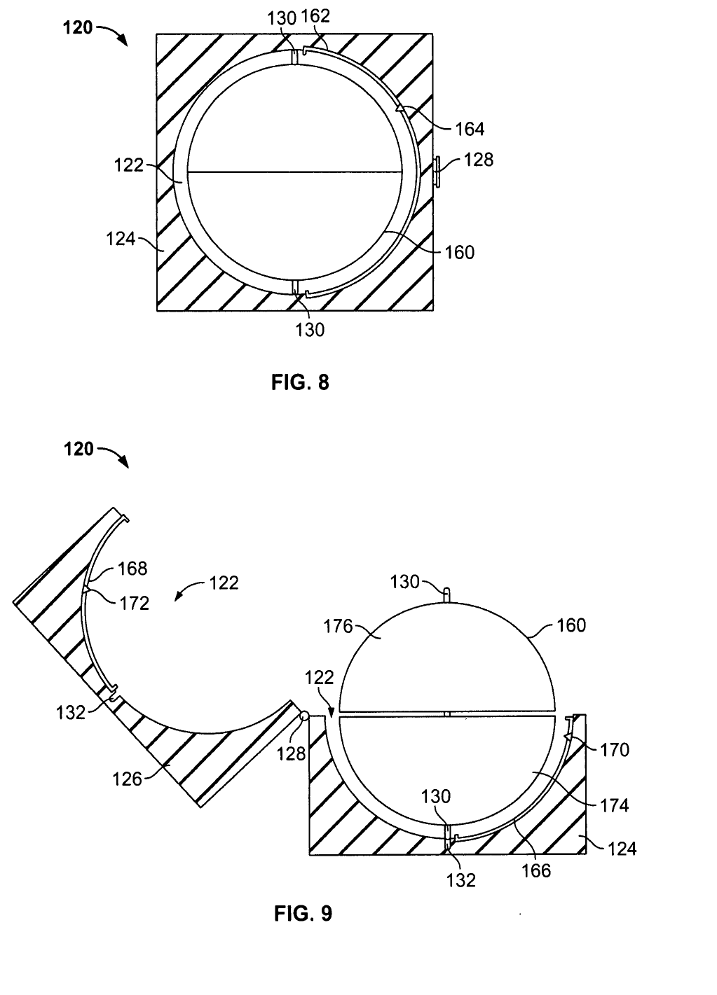

FIGS. 8 and 9 show a spherical storage medium 160, similar to the embodiments of FIGS. 3 and 4 secured in a drive 120. In FIGS. 8 and 9, the storage medium 160 is rotated about a vertical axis; however, the axis of rotation can be at any orientation. In FIG. 8, the drive 120 includes first and second spindles 130 that engage opposite poles of the storage medium 160. In FIG. 9, the drive 120 includes first and second seat portions 132 that engage the spindles 130 on the storage medium 160. In FIG. 8, a single guide 162 spans the distance between the poles of the spherical body 160 and a read/write head 164 is positioned on the guide, similar to the embodiment of FIG. 6. A motor and controller similar to that of FIGS. 6 and 7 may also be coupled to the drive.

FIG. 9 includes a first and second rail 166, 168. The first rail 166 is positioned along an arc that spans the distance from one pole to the equator and has a first read head 170 mounted thereon. The second rail 168 is positioned along an arc that spans the distance from the other pole to the equator and has a second read head 172 mounted thereon. In particular, the first rail is located on the base portion 124 and the second rail 168 is located on the lid portion. The first and second read heads 170, 172 can be independently positioned along the first and second rails 166, 168, respectively. The read heads 170, 172 read data from a corresponding hemisphere of the storage medium. Specifically, the read heads 170, 172 can read data from the hemispheres 174, 176 of the spherical storage medium 160 simultaneously, because the hemispheres are capable of moving independently with respect to one another and the read heads are positionable along the rails 166, 168 independently with respect to one another. A motor and controller similar to that of FIGS. 6 and 7 may also be coupled to the drive. Other embodiments of the three-dimensional storage medium may use spheres that are segmented further, and use drives that include a rail and read head combination for each segment. The read heads may include or be replaced with write heads to store data on any location of the storage medium.

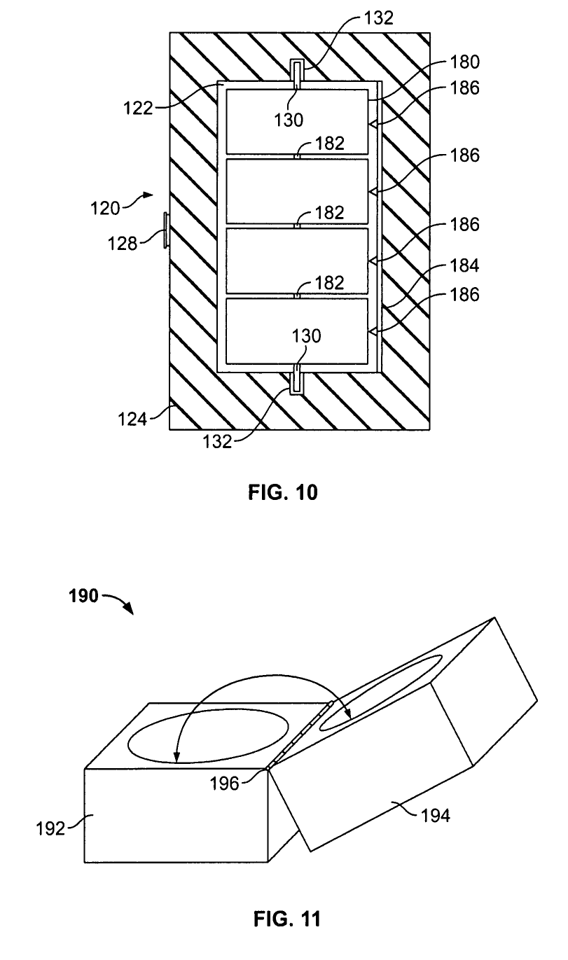

FIG. 10 shows a cylindrical storage medium 180 similar to FIG. 5A secured in a drive 120. A spindle 182 on the storage medium 180 is secured to seat portions 132 of the drive 120 and is further coupled to a motor and controller (not shown) for independently spinning the segments of the storage medium 180. A single rail 184 includes multiple read/write heads 186 that are coupled to the motor for accessing/storing data on respective segments of the storage medium 180. The rail 184 extends along the height of the cylinder 180 along a line that is generally equidistant at all points thereof from the radius of the cylinder. In other embodiments, additional rails may be included for guiding multiple read/write heads. Furthermore, the rails may be coupled to the motor so that they can be rotated with respect to the drive.

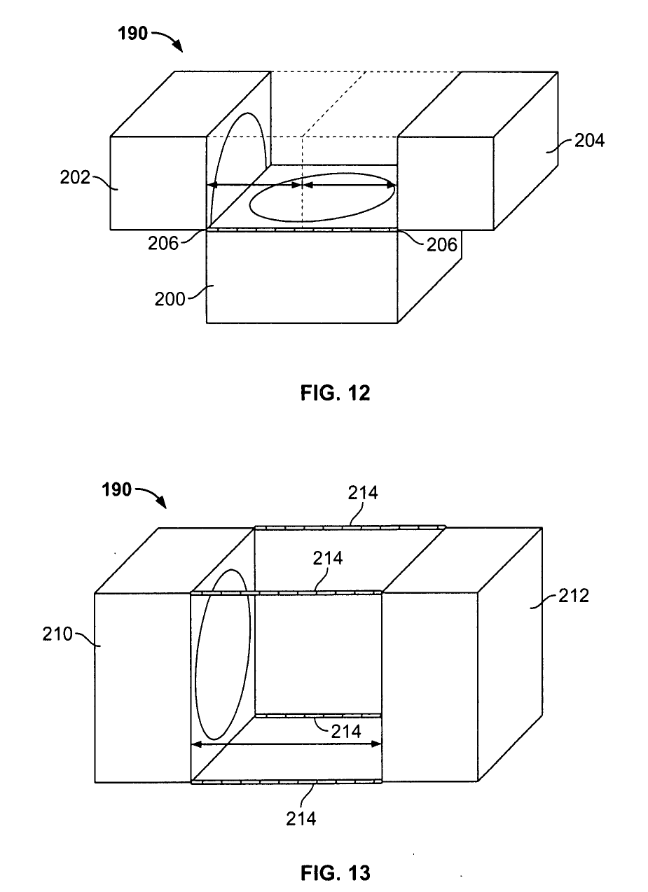

FIGS. 11-13 show various embodiments of a cuboid drive mechanism 190 that can be opened and closed to accept a storage medium in an opening therein. In FIG. 11, the drive 190 includes a base portion 192 and a lid portion 194 connected along a hinge 196. Each portion generally houses half of the storage medium and the base and lid portions 192, 194 flip open about the hinge 196 to allow access into the drive 190. In FIG. 12, the drive 190 has a base portion 200 that generally houses half of the storage medium and an upper portion that is divided into two generally equal halves 202, 204 along a line of separation perpendicular to the base portion. The drive 190 in FIG. 12 opens by sliding apart the halves 202, 204 of the upper portion along suitable mounts 206. In FIG. 13, the drive 190 includes two generally equal halves 210, 212 that slide apart longitudinally along suitable mounts 214. One half can remain stationary while the other half slides away or both halves may move apart from each other.

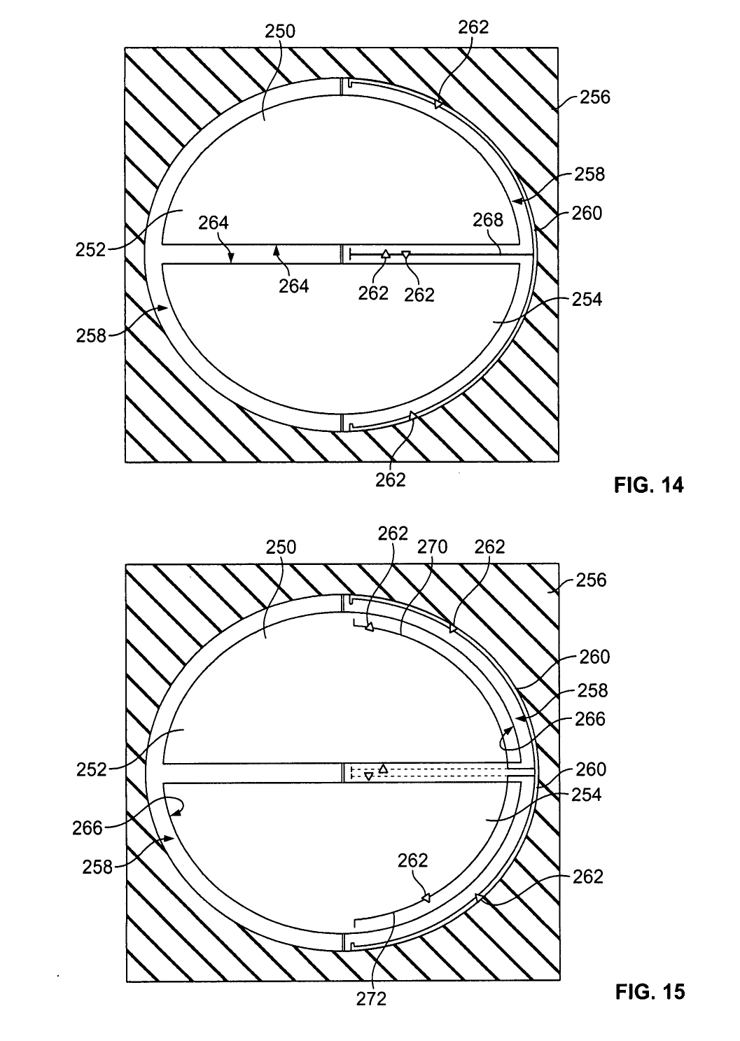

FIGS. 14 and 15 show embodiments of a spherical storage medium 250 segmented into two hemispheres 252, 254 along the equator, wherein the storage medium is housed in a drive 256 similar to the embodiments of FIGS. 8 and 9. The storage mediums in FIGS. 14 and 15 both can be encoded with data on the outer radius of the storage medium 258, and consequently, the drives 256 include external rails 260 and read/write heads 262 similar to the embodiments previously described herein. However, in FIG. 14 the flat circumferential areas 264 between the hemispheres can also be utilized to encode data, and in FIG. 15 the curved inner radial surfaces 266 can be used to encode data. In FIG. 14, the drive 256 further includes an additional guide rail 268 located between the adjacent hemispheres 252, 254. Read/write heads 262 are moveably disposed on the guide rail 268 to randomly access and record data on the flat circumferential areas 264 of the respective segments 252, 254. In another embodiment, two guide rails may be used along which read/write heads are positioned. The drive 256 of FIG. 15 includes two additional arcuate guide rails 270, 272, wherein read/write heads 262 are moveably disposed on the arcuate guide rails. The arcuate guide rails 270, 272 are initially positioned adjacent to each other (shown in dotted lines) to allow the storage medium 250 to be easily placed in the drive 256. Once the storage medium 250 is placed in the drive 256, the arcuate guide rails 270, 272 are rotated apart to position the read/write heads 262 along the curved inner radial surfaces 266 of the respective segments 252, 254 to randomly access and record data thereon. In other embodiments, the arcuate guide rails remain stationary and the storage medium is partially separable to fit the segments between the opposing arcuate guide rails.

### INDUSTRIAL APPLICABILITY

This invention is useful in storing data on a three-dimensional storage medium and for randomly accessing the stored data to increase data storage and the speed in which data is accessed and stored.

Numerous modifications to the present invention will be apparent to those skilled in the art in view of the foregoing description. Accordingly, this description is to be construed as illustrative only and is presented for the purpose of enabling those skilled in the art to make and use the invention, as well as, to teach the best mode of carrying out the same. The exclusive rights to all modifications that come within the scope of the appended claims are reserved.

We claim:

1. A medium for storing data comprising:
a rotationally symmetric body, wherein the body is divided into a plurality of independently positionable segments;
a recordable substrate affixed to a surface of at least one of the segments; and
at least one mount to enable the segments to be coupled to a drive mechanism.

2. The medium of claim 1 wherein the recordable substrate is affixed to an outer surface of at least one of the segments.

3. The medium of claim 1 wherein the recordable substrate is affixed to an inner surface of at least one of the segments.

4. The medium of claim 3 wherein the recordable substrate is affixed to a flat inner circumferential surface of at least one of the segments.

5. The medium of claim 3 wherein the recordable substrate is affixed to a curved inner radial surface of at least one of the segments.

6. The medium of claim 1 wherein the body is an ellipsoidal body.

7. The medium of claim 6 wherein the body is a spherical body.

8. The medium of claim 1 further comprising an internal frame structure.

9. The medium of claim 8 wherein the internal frame structure includes a solid core drive shaft and a plurality of hollow drive shafts positioned around the solid core drive shaft.

10. An apparatus for accessing data stored on a substrate affixed to a surface of an ellipsoidal body coupled to the apparatus, the apparatus comprising:
a guide external to the ellipsoidal body;
a read head moveably disposed on the guide;
a motor for spinning the ellipsoidal body; and
a controller coupled to the apparatus for positioning the read head along the guide.

11. The apparatus of claim 10 wherein the ellipsoidal body is divided into a plurality of segments.

12. The apparatus of claim 11 wherein the ellipsoidal body is a spherical body.

13. The apparatus of claim 11 wherein the guide is an arcuate guide generally extending radially between opposite poles of the body, and wherein one or more additional read heads are moveably disposed on the arcuate guide.

14. The apparatus of claim 11 wherein the guide is an arcuate guide generally extending radially from one pole to the equator, and wherein a second arcuate guide is external to the ellipsoidal body generally extending radially from the equator to the opposite pole, and further wherein one or more additional read heads are moveably disposed on the first-named arcuate guide or the second arcuate guide.

15. The apparatus of claim 11 further comprising at least one rail internal to the ellipsoidal body positioned between adjacent segments of the ellipsoidal body, wherein one or more read heads are moveably disposed on the at least one rail.

16. The apparatus of claim 11 further comprising a plurality of arcuate rails internal to the ellipsoidal body positioned between adjacent segments of the ellipsoidal body, wherein one or more read heads are moveably disposed on the plurality of arcuate rails, and further wherein the arcuate rails are moveable.

17. The apparatus of claim 10 wherein the apparatus is adapted to record data to the ellipsoidal body, and wherein the apparatus includes a write head moveably disposed on the guide.

18. A method for accessing data stored on a substrate affixed to the surface of a body, comprising the steps of:
providing a rotationally symmetric body that is divided into a plurality of segments, wherein a recordable substrate is affixed to a surface of at least one of the segments;
controlling each segment to spin independently of the other segments; and
moving a plurality of read heads along at least one guide located externally to the body.

19. The method of claim 18 further comprising moving at least one read head along a rail located internally to the body along an inner area of the segments of the body.

20. The method of claim 18 further comprising the step of interleaving data on each segment and/or across the plurality of segments.
